(19) United States
(12) Patent Application Publication
(10) Pub. No.: US 2015/0200485 A1
(43) Pub. Date: Jul. 16, 2015

(54) BATTERY CONNECTOR WITH WATER-PROOF PROTECTIVE COVER

(71) Applicant: ALLTOP ELECTRONICS (SUZHOU) LTD., Taicang City (CN)

(72) Inventors: Wang-I YU, JHONGHE City (TW); Hung-Chi TAI, JHONGHE City (TW); Yung-Chih HUNG, JHONGHE City (TW); I-Hung CHENG, JHONGHE City (TW); Jie-Jun ZENG, JHONGHE City (TW)

(73) Assignee: ALLTOP ELECTRONICS (SUZHOU) LTD., Taicang City (CN)

(21) Appl. No.: 14/300,988

(22) Filed: Jun. 10, 2014

(30) Foreign Application Priority Data
Jan. 16, 2014 (CN) 201410019416.8

(51) Int. Cl. H01R 13/52; H01R 13/66; H01R 24/20

(52) U.S. Cl. CPC H01R 13/52; H01R 24/20; H01R 13/665

(57) ABSTRACT

A battery connector includes an insulative housing, a contact retained in the insulative housing and a water-proof protective cover tightly covering the insulative housing. The insulative housing includes a mating surface, a mounting surface and a receiving space extending forwardly through the mating surface. The contact is retained in the receiving space. The contact includes a rear section, a mounting tail extending beyond the protective cover, first and second protrusions extending forwardly from opposite lateral sides of the rear section, and first and second contacting sections extending inwardly and backwardly from the first and the second protrusions, respectively. The water-proof protective cover tightly covers the mounting surface of the insulative housing.

### BACKGROUND

1. Technical Field

The present disclosure relates to a battery connector, and more particularly to a battery connector with a water-proof protective cover.

2. Description of Related Art

Electric transportation tools, i.e., electric vehicles or electric bicycles, have been more and more popular because of their wide energy source, quiet driving feeling and non-pollution discharge for environment protection. Generally, the electric transportation tools apply electric storage devices, i.e., rechargeable batteries etc., as their energy sourcing and providing mediums. Usually, the rechargeable batteries are mounted on a vehicle body. When the electric quality of the rechargeable batteries is insufficient, such rechargeable batteries may need to charge from a power supply via a battery connector. Obviously, because of different usage occasions, the water-proof requirement of the battery connectors is much higher than conventional connectors.

It is desirable to provide a battery connector with an improved water-proof structure.

### SUMMARY

The present disclosure includes a battery connector including an insulative housing, a contact retained in the insulative housing and a water-proof protective cover tightly covering the insulative housing. The insulative housing includes a mating surface, a mounting surface opposite to the mating surface and a receiving space extending forwardly through the mating surface. The contact is retained in the receiving space. The contact includes a rear section, a mounting tail extending from the rear section, first and second protrusions extending forwardly from opposite lateral sides of the rear section, and first and second contacting sections extending inwardly and backwardly from the first and the second protrusions, respectively. The water-proof protective cover tightly covers the mounting surface of the insulative housing. The mounting tail extends through the protective cover for being connected to a circuit board.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a battery connector in accordance with an illustrated embodiment of the present disclosure;

FIG. 2 is an exploded view of the battery connector as shown in FIG. 1;

FIG. 3 is a perspective view of an insulative housing of the battery connector as shown in FIG. 2;

FIG. 4 is another perspective view of the insulative housing as shown in FIG. 3;

FIG. 5 is a perspective view of one of contacts of the battery connector;

FIG. 6 is a perspective view of an inner cap as shown in FIG. 2; and

FIG. 7 is a perspective view of a protective cover as shown in FIG. 2.

### DETAILED DESCRIPTION OF THE ILLUSTRATED EMBODIMENT

Reference will now be made to the drawing figures to describe the embodiments of the present disclosure in detail. In the following description, the same drawing reference numerals are used for the same elements in different drawings.

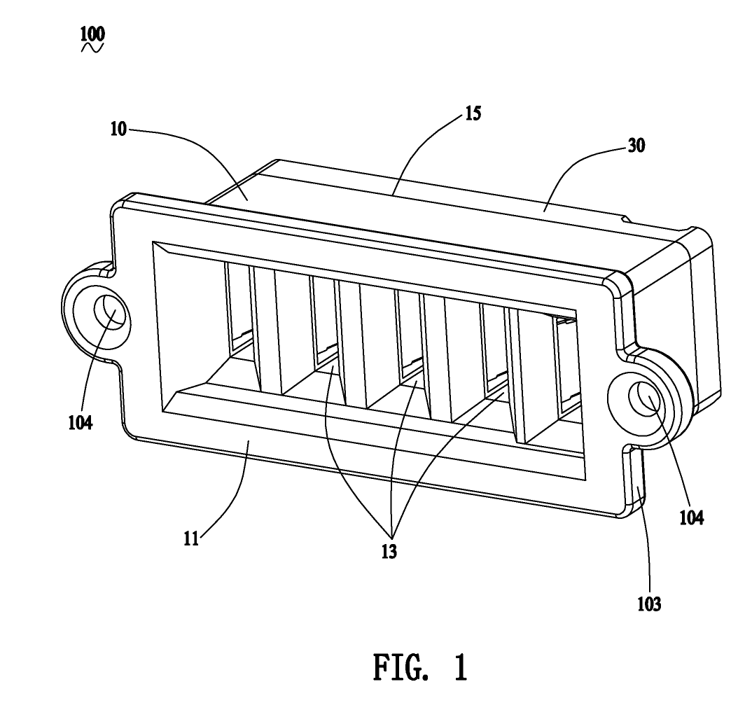

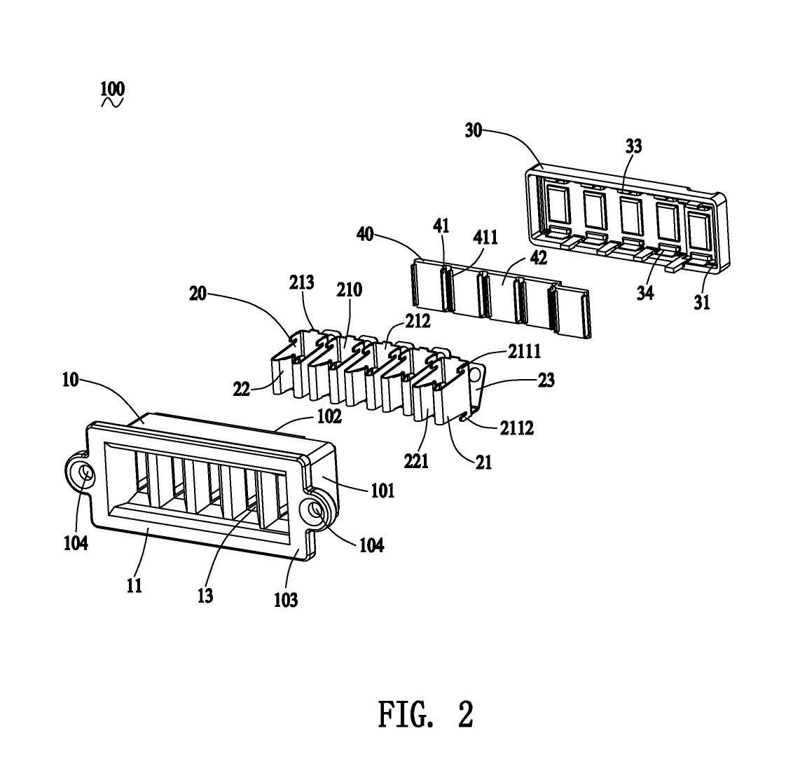

Referring to FIGS. 1 and 2, an illustrated embodiment of the present disclosure discloses a battery connector 100 adapted for mating with a complementary connector (not shown) for battery charging. The battery connector 100 includes an insulative housing 10, a plurality of contacts 20 fixed in the insulative housing 10, an inner cap 40 for engaging against the contacts 20 and a water-proof protective cover 30 tightly covering the inner cap 40. According to the illustrated embodiment of the present disclosure, the protective cover 30 is insert-molded with a rear end of the insulative housing 10.

Referring to FIGS. 1 to 4, the insulative housing 10 includes a body portion 101 and a contracted portion 102 protruding rearwardly from the body portion 101. The body portion 101 includes a mating surface 11 and a rectangular mounting flange 103 peripherally positioned at the body portion 101. The mounting flange 103 includes a pair of mounting holes 104 at lateral sides thereof. The contracted portion 102 comprises a mounting surface 12 opposite to and in parallel with the mating surface 11. A plurality of receiving spaces 13 are defined extending through the mating surface 11 and the mounting surface 12 along a first direction A-A. The receiving spaces 13 are arranged side by side along a second direction B-B perpendicular to the first direction A-A.

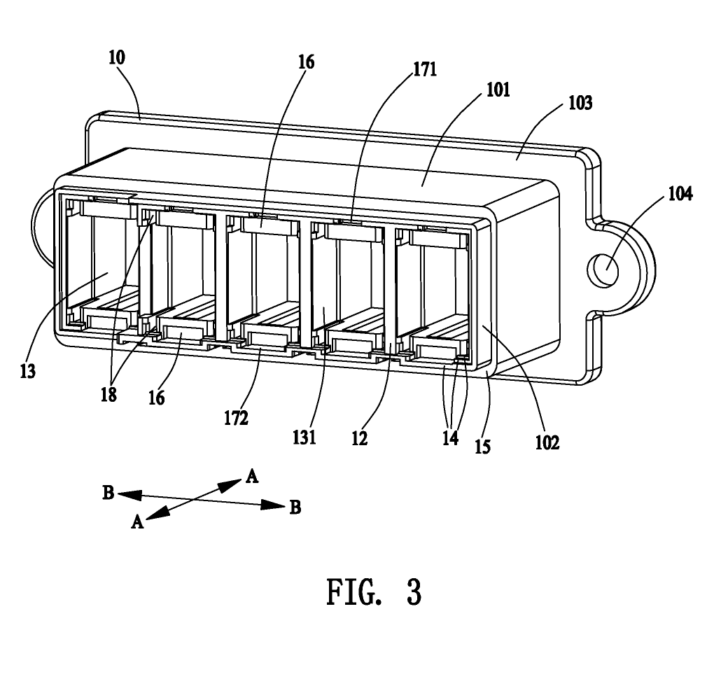

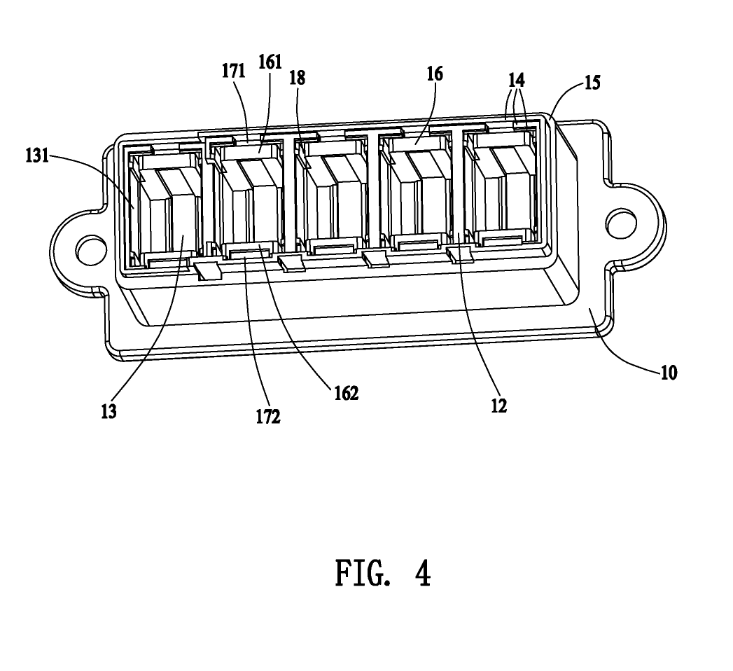

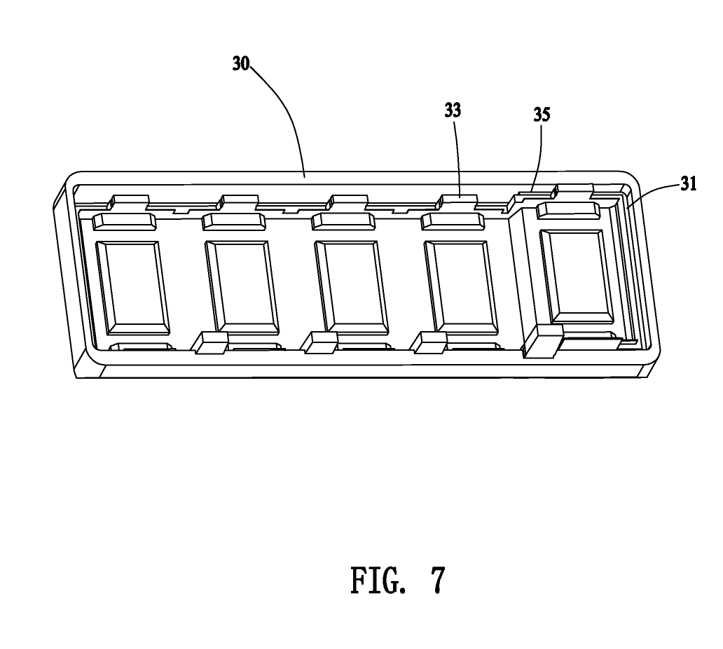

Referring to FIGS. 3 and 4, the contracted portion 102 includes a plurality of stepped walls 14 adjacent to the mounting surface 12. Referring to FIG. 7, the protective cover 30 includes a plurality of stepped recesses 35 to tightly mate with the stepped walls 14. As a result, the step walls 14 and the stepped recesses 35 jointly form water-proof steps in order to increase water fluid distance. The insulative housing 10 includes a plurality of stop members 16 in communication with corresponding receiving spaces 13. The stop members 16 are adapted for abutting against the contacts 20 for position restriction. According to the illustrated embodiment of the present disclosure, each stop member 16 includes an upper stop wall 161 and a lower stop wall 162 separated a distance from the upper stop wall 161. The insulative housing 10 further includes an upper depression 171 adjacent to and on top of the upper stop wall 161, and a lower depression 172 adjacent to and on bottom of the lower stop wall 162. Furthermore, the insulative housing 10 includes a plurality of slots 18 at opposite lateral sides of each receiving space 13. The slots 18 extend rearwardly through the mounting surface 12. The slots 18 are in communication with corresponding receiving spaces 13 for cooperatively receiving the contacts 20. Each inner wall at opposite sides of the receiving spaces 13 defines a restricting slit 131 in communication with corresponding slot 18 and corresponding receiving space 13.

Referring to FIGS. 2 to 5, each contact 20 includes a U-shaped body 21, a pair of first and second contacting sections 22 for mating with the complementary connector and a mounting tail 23 extending beyond the insulative housing 10 for being connected to a circuit board. The pair of first and second contacting sections 22 are symmetrical with each other. The U-shaped body 21 includes a rear section 212, a pair of first and second protrusions 215 extending forwardly from opposite lateral sides of the rear section 212, and a space 210 formed by the rear section 212 and the two protrusions 215. The first and second contacting sections 22 extend inwardly and backwardly from the first and the second protrusions, respectively. The first and second contacting sections 22 extend into the space 210. The mounting tail 23 extends from the rear section 212 along a third direction different from the first direction A-A and the second direction B-B. According to the illustrated embodiment of the present disclosure, the mounting tail 23 is of an inclined configuration.

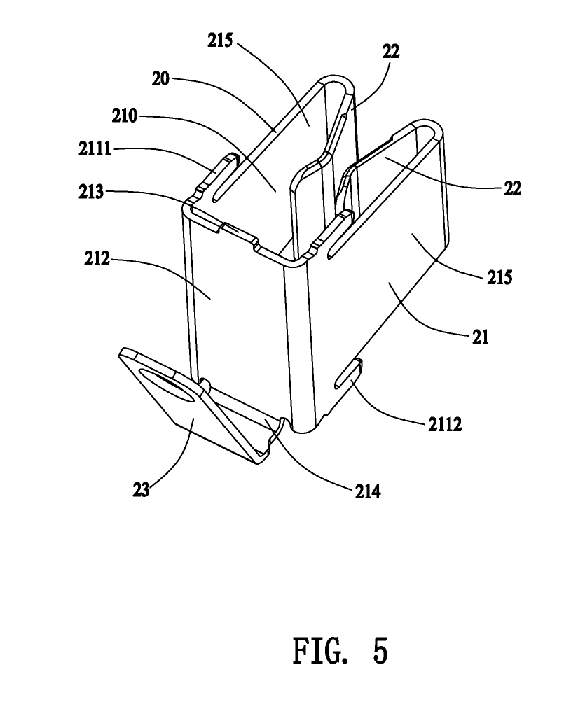

Referring to FIG. 5, the rear section 212 of each contact 20 includes an upper protrusion 213 received in the upper depression 171 and a lower protrusion 214 received in the lower depression 172 for position restriction. Each of the first and the second protrusions 215 includes an upper barb 2111 and a lower barb 2112. When the contacts 20 are assembled into the receiving spaces 13 in position, the upper barbs 2111 and the lower barbs 2112 are fixed in the corresponding slots 18, and the upper stop walls 161 and the lower stop walls 162 abut against the rear sections 212 of the contacts 20 for preventing the contacts 20 for being over-inserted into the receiving spaces 13. Besides, the upper stop walls 161 and the lower stop walls 162 can also be adapted for preventing excessive injection during the insert-molding process.

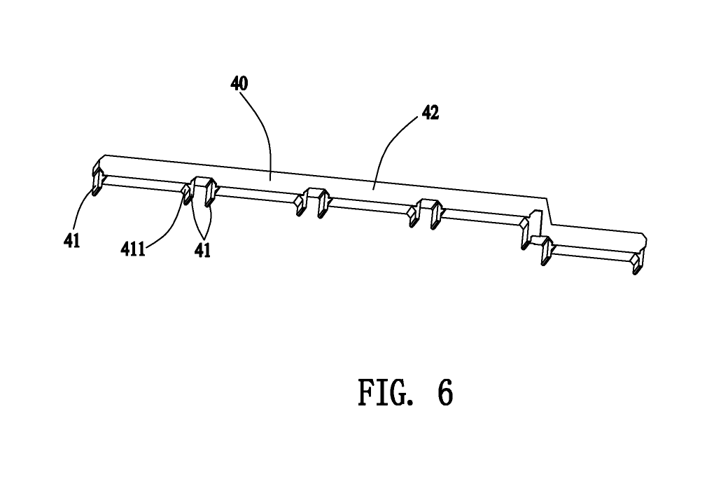

Referring to FIGS. 2 and 6, the inner cap 40 is made of an insulative material and includes a body portion 42 and a plurality of projections 41 extending forwardly from the body portion 42. Each projection 41 is tightly inserted into a gap formed between corresponding protrusion 215 and an inner surface of the insulative housing 10. Understandably, in assembling, the projections 41 are tightly inserted into corresponding restricting slits 131. Besides, each projection 41 includes an inclined surface 411 which is not only easy for guiding insertion of the inner cap 40 into the insulative housing 10, but also for filling in the gap for preventing excessive injection. With the inner cap 40 filling in certain spaces between the contacts 20 and the inner walls of the insulative housing 10, excessive injection during the insert-molding process can be decreased.

Referring to FIGS. 1, 2 and 7, the protective cover 30 defines a recess 31 to receive the contracted portion 102 of the insulative housing 10. The mounting tail 23 extends beyond the protective cover 40 through a slit 34. After insert-molding, the step walls 14 and the stepped recesses 35 are in tightly mating with each other for dust prevention and water prevention. Besides, at a joint 15 of the body portion 101 and the protective cover 40, corresponding peripheral surfaces of the protective cover 40 and the body portion 101 are coplanar with each other (as best shown in FIG. 1). As a result, the profile of the battery connector 100 can be regulated. Furthermore, the protective cover 30 includes a plurality protrusion blocks 33 which are inserted into corresponding upper depressions 171 for sealing the gap between the protective cover 30 and the insulative housing 10.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A battery connector comprising:
an insulative housing comprising a mating surface, a mounting surface opposite to the mating surface and a receiving space extending forwardly through the mating surface;
a contact retained in the receiving space, the contact comprising a rear section, a mounting tail extending from the rear section, first and second protrusions extending forwardly from opposite lateral sides of the rear section, and first and second contacting sections extending inwardly and backwardly from the first and the second protrusions, respectively; and
a water-proof protective cover tightly covering the mounting surface of the insulative housing, the mounting tail extending through the protective cover for being connected to a circuit board.

2. The battery connector as claimed in claim 1, wherein the protective cover is insert-molded to the mounting surface of the insulative housing.

3. The battery connector as claimed in claim 1, wherein the mounting tail is of an inclined configuration with respect to the protective cover.

4. The battery connector as claimed in claim 1, wherein the insulative housing comprises a body portion and a contracted portion protruding rearwardly from the body portion, the mounting surface being formed on the contracted portion, the protective cover defining a recess to receive the contracted portion.

5. The battery connector as claimed in claim 4, wherein at a joint of the body portion and the protective cover, corresponding peripheral surfaces of the protective cover and the body portion are coplanar with each other.

6. The battery connector as claimed in claim 4, wherein the contracted portion comprises a stepped wall adjacent to the mounting surface, and the protective cover comprises a stepped recess to tightly attach the stepped wall.

7. The battery connector as claimed in claim 1, wherein the insulative housing comprises a stop member in communication with the receiving space, and the stop member is adapted for abutting against the rear section of the contact for position restriction.

8. The battery connector as claimed in claim 7, wherein the stop member comprises an upper stop wall and a lower stop wall, the insulative housing comprising an upper depression adjacent to the upper stop wall and a lower depression adjacent to the lower stop wall, the rear section of the contact comprising an upper protrusion received in the upper depression and a lower protrusion received in the lower depression.

9. The battery connector as claimed in claim 1, wherein at least one of the first and the second protrusions comprises a barb, and the insulative housing defines a slot extending through the mounting surface to retain the barb.

10. The battery connector as claimed in claim 1, further comprising an inner cap assembled to the insulative housing to engage against the contact, and the inner cap is positioned between the rear section and the protective cover.

11. The battery connector as claimed in claim 10, wherein the inner cap comprises a body portion and a plurality of projections extending forwardly therefrom, each projection being tightly inserted into a gap between corresponding protrusion and an inner wall of the insulative housing.

12. A battery connector comprising:
an insulative housing comprising a mating surface, a mounting surface opposite to the mating surface and a plurality of receiving spaces extending forwardly through the mating surface along a first direction, the receiving spaces being arranged side by side along a second direction perpendicular to the first direction;
a plurality of contacts retained in the receiving spaces, each contact comprising a rear section, a mounting tail, first and second protrusions extending forwardly from opposite lateral sides of the rear section, and first and second contacting sections extending inwardly and backwardly from the first and the second protrusions, respectively;
an inner cap engaging against the contacts; and
a water-proof protective cover insert-molded with the mounting surface of the insulative housing so that the protective cover, the inner cap and the insulative housing are integral with each other, the inner cap being positioned between the rear sections and the protective cover, the mounting tails of the contacts extending through the protective cover for being connected to a circuit board.

13. The battery connector as claimed in claim 12, wherein each mounting tail is of an inclined configuration and extends along a third direction different from the first direction and the second direction.

14. The battery connector as claimed in claim 12, wherein the insulative housing comprises a body portion and a contracted portion protruding rearwardly from the body portion, the mounting surface being formed on the contracted portion, the protective cover defining a recess to receive the contracted portion.

15. The battery connector as claimed in claim 14, wherein at a joint of the body portion and the protective cover, corresponding peripheral surfaces of the protective cover and the body portion are coplanar with each other.

16. The battery connector as claimed in claim 14, wherein the contracted portion comprises a stepped wall adjacent to the mounting surface, and the protective cover comprises a stepped recess to tightly attach the stepped wall.

17. The battery connector as claimed in claim 12, wherein the insulative housing comprises a plurality of stop members in communication with corresponding receiving spaces, and the stop members are adapted for abutting against the rear sections of the contacts for position restriction.

18. The battery connector as claimed in claim 17, wherein each stop member comprises an upper stop wall and a lower stop wall, the insulative housing comprising a plurality of upper depressions adjacent to corresponding upper stop walls and a plurality of lower depressions adjacent to corresponding lower stop walls, each rear section of the contacts comprising an upper protrusion received in the upper depression and a lower protrusion received in the lower depression.

19. The battery connector as claimed in claim 12, wherein at least one of the first and the second protrusions comprises a barb, and the insulative housing defines a slot extending through the mounting surface to retain the barb.

20. The battery connector as claimed in claim 12, wherein the inner cap comprises a body portion and a plurality of projections extending forwardly therefrom, each projection being tightly inserted into a gap between corresponding protrusion and an inner wall of the insulative housing.
